(19) United States
(12) Patent Application Publication
(10) Pub. No.: US 2016/0042563 A1
(43) Pub. Date: Feb. 11, 2016

(54) AUGMENTED REALITY INFORMATION MANAGEMENT

(71) Applicant: EMPIRE TECHNOLOGY DEVELOPMENT LLC, WILMINGTON, DE (US)

(72) Inventors: SHMUEL UR, SHORASHIM (IL); DAVID ASH, BELLEVUE, WA (US); VLAD DABIJA, MOUNTAIN VIEW, CA (US)

(21) Appl. No.: 14/456,107

(22) Filed: Aug. 11, 2014

(51) Int. Cl. G06T 19/00; G06T 7/00

(52) U.S. Cl. CPC G06T 19/006; G06T 7/0042; G06T 2215/16; G06T 2219/004

(57) ABSTRACT

Technologies related to Augmented Reality (AR) information management are generally described. In some examples, a computing device which receives multiple AR information display requests (AR requests) may prioritize and limit the AR requests to display prioritized AR requests which are displayable by the computing device in substantially real-time. The computing device may select a set of AR requests for display within a real-time view frame, prioritize the AR requests, and display a real-time limited subset of the higher priority AR requests. The computing device may subsequently display additional AR requests according to AR request priority, such that AR request priority determines timing of displaying each respective additional AR request.

### BACKGROUND

Unless otherwise indicated herein, the materials described in this section are not prior art to the claims in this application and are not admitted to be prior art by inclusion in this section.

Augmented Reality (AR) generally provides a view of a physical environment while supplementing the physical environment with computer-generated items such as images, text, sound, or video. For example, a person may view the physical environment in front of them on a mobile device's display, or through AR goggles or glasses such as GOOGLE GLASS®. The device may supplement the viewed environment with a variety of computer-generated items. For example, the device may recognize objects in the device's display and may overlay information about the recognized objects, or the device may overlay game characters which may interact with the viewed environment. While AR has the potential to provide a variety of beneficial and entertaining new technologies, AR is still in a relatively early stage of development, and there are many challenges to address as AR matures.

### SUMMARY

The present disclosure generally describes technologies including devices, methods, and computer readable media relating to AR information management. Some example methods may enable a computing device which receives multiple AR information display requests (AR requests) to prioritize and limit received AR requests and to display prioritized AR requests which are displayable by the computing device in substantially real-time. Each AR request may comprise, e.g., position information that defines where, within an AR environment, the computing device may display the AR request; time information that defines a time period during which the computing device may display the AR request; and/or AR request payload information that defines information for display by the computing device within the AR environment. The computing device may select a set of AR requests for display within a real-time view frame comprising at least a portion of the AR environment. The selected set of AR requests may comprise, e.g., position information defining positions within the real-time view frame and/or time information comprising unexpired time periods. The computing device may prioritize AR requests in the selected set of AR requests to establish prioritized AR requests comprising higher priority and lower priority AR requests. The computing device may display, within the real-time view frame, AR request payload information for at least a subset of the higher priority AR requests within the prioritized AR requests, wherein the displayed subset of the higher priority AR requests may comprise a real-time limited subset displayable by the computing device in substantially real-time. The computing device may subsequently display AR request payload information for one or more additional AR requests within the prioritized AR requests, and a priority associated with each respective additional AR request may determine timing of subsequently displaying each respective additional AR request.

Computing devices and computer readable media having instructions implementing the various technologies described herein are also disclosed. Example computer readable media may comprise non-transitory computer readable storage media having computer executable instructions executable by a processor, the instructions that, when executed by the processor, cause the processor to carry out any combination of the various methods provided herein. Example computing devices may include an AR device comprising a processor, a memory, and an AR information manager configured to carry out the methods described herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a diagram illustrating an example AR device;

FIGS. 2A, 2B, 2C, and 2D are diagrams illustrating example real-time view frames of an example AR environment;

FIG. 3 is a block diagram of a computing device as one example of an AR device;

FIG. 4 is a flow diagram illustrating an example AR information management method; and

FIG. 5 is a diagram illustrating an example AR request source device and method to generate AR requests, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

The present disclosure is generally drawn, inter alia, to technologies including methods, devices, systems and/or computer readable media deployed therein relating to AR information management. In some examples, a computing device which receives multiple AR requests may prioritize and limit the AR requests to display prioritized AR requests which are displayable by the computing device in substantially real-time. The computing device may select a set of AR requests for display within a real-time view frame, prioritize the AR requests, and display a real-time limited subset of the higher priority AR requests. The computing device may subsequently display additional AR requests according to AR request priority, such that AR request priority determines timing of displaying each respective additional AR request.

In one example scenario, a device user in a physical environment, such as a coffee shop or any other physical environment, may use an example AR device arranged according to this disclosure, such as a laptop, smartphone or tablet type mobile device equipped with an AR application, or AR goggles or glasses such as a GOOGLE GLASS® type device, to view AR information. The AR information may be received by the example AR device in the form of “AR information display requests”, referred to herein as “AR requests”.

The example AR device may receive AR requests from any of a wide variety of AR request sources. Example AR request sources may include: a remote AR server adapted to send AR requests to AR devices, optionally based on AR device location and/or user AR information preferences; a local server, e.g., in the coffee shop, adapted to send AR requests to proximal AR devices, e.g., AR devices in or near the coffee shop; a mobile device, such as a laptop, smartphone or tablet type mobile device, e.g., in possession of a coffee shop customer or employee, wherein the mobile device may be adapted to send AR requests to proximal AR devices; a smart environmental sensor or other smart equipment adapted to send AR requests to proximal AR devices, such as a smart coffee cup equipped to send AR requests including temperature of the coffee cup, or a smart Radio Frequency Identification (RFID) reader equipped to send AR requests including identity of RFID badge holders; a vehicle-based or roadside computing device adapted to send AR requests to proximal AR devices, e.g., AR requests comprising vehicle status and/or road condition information; a local AR request generator, e.g., an application or other process executed by the example AR device and adapted to supply AR requests for use by the example AR device, for example, AR requests based on objects recognized through object recognition processes, or AR requests based on Quick Response (QR) codes or other information recognized within a physical environment; and/or any other sources of AR requests as may be developed.

In some embodiments, AR requests may comprise, e.g., position information that defines where, within an AR environment, the example AR device may display the AR request; time information that defines a time period during which the example AR device may display the AR request; and/or AR request payload information that defines information for display by the example AR device within the AR environment. AR requests may furthermore comprise any information disclosed herein or as may be included by those of skill in the art with the benefit of this disclosure.

The example AR device may be adapted to manage received AR requests as described herein, and to display at least a subset of the received AR requests. Displaying AR requests may comprise displaying the AR requests in an “AR environment”. The term “AR environment” as used herein refers to a physical environment viewable on or through an AR device display with overlaid AR information. For example, an AR environment may comprise the example coffee shop or any other environment, as viewed at the example AR device.

The AR environment may be viewed at the example AR device as one or more real-time view frames comprising at least portions of the AR environment. For example, when the example AR device is oriented toward the coffee shop counter, example real-time view frames may comprise the coffee shop counter along with any people or physical features at or near the counter, such as may be viewed by the example AR device's camera. When the example AR device is oriented toward the tables and chairs, example real-time view frames may comprise the tables and chairs along with any people or physical features at or near the tables and chairs. In other embodiments, an AR environment may be presented in a “map” view, comprising, e.g., a map of the AR environment such as a map of the coffee shop's floor plan. In a map view of an AR environment, example real-time view frames may be different from real-time view frames as may be viewed through the AR device's camera, as will be appreciated.

The example AR device may be adapted to display AR requests within an AR environment according to the respective position information of each AR request. For example, in the coffee shop, the example AR device may be adapted to display AR requests comprising position information at or near the counter, at their positions at or near the counter. The example AR device may be adapted to display AR requests comprising position information at or near the tables or chairs, at their positions at or near the tables or chairs. Other AR requests may comprise position information defining positions elsewhere in the AR environment.

As a result, in some embodiments, different AR requests may come into and out of view as the example AR device pans across the coffee shop or other AR environment. In other words, different AR requests may come into and out of view, based on which AR requests are included in real-time view frames viewed at the example AR device. The example AR device may be adapted to display AR requests having positions within a current real-time view frame of the AR environment.

Managing received AR requests may generally account for factors such as AR request priority, time windows during which AR requests may be relevant, position information associated with AR requests, and AR request processing time which may affect whether AR requests are displayable by the example AR device in substantially real-time. The example AR device may manage received AR requests in a manner allowing the example AR device to display, within each real-time view frame, AR request payload information for at least higher priority AR requests as appropriate for each respective real-time view frame. The displayed higher priority AR requests may comprise a real-time limited subset of higher priority AR requests displayable by the example AR device in substantially real-time.

In some embodiments, managing received AR requests may comprise selecting a set of AR requests for display within a real-time view frame comprising at least a portion of the AR environment. The example AR device may be adapted to store received AR requests, and to select sets of AR requests from among stored AR requests. For example, the example AR device may be adapted to select a new set of AR requests for display within each new real-time view frame, as each new real-time view frame comes into view at the example AR device.

In some embodiments, the example AR device may be adapted to select sets of AR requests using AR request position information. Each AR request in a selected set of AR requests may comprise, e.g., position information defining a position within a real-time view frame viewed at the example AR device. The example AR device may be adapted to apply any other selection criteria for AR request selection, in combination with AR request position information. In some embodiments, the example AR device may be adapted to select sets of AR requests using AR request time information. Each AR request in a selected set of AR requests may comprise, e.g., time information that defines an unexpired time period for the AR request.

In some embodiments, managing received AR requests may comprise applying constraints to exclude AR requests from the selected set of AR requests. Constraints may apply any constraint criteria. For example, the example AR device may be adapted to apply a “previously displayed” constraint, a user preference constraint, and/or a distance constraint.

In an example “previously displayed” constraint, AR requests for which AR request payload information has been “previously displayed” may be excluded from the selected set of AR requests. “Previously displayed” may be defined as desired for particular embodiments. In some embodiments, an AR request may be considered as “previously displayed” after the AR request is displayed 1, 2, 3, . . . times. In some embodiments, an AR request may be considered as “previously displayed” after the AR request is displayed for an aggregate time period such as 1, 2, 3, 4, 5, . . . seconds. In some embodiments, an AR request may be considered as “previously displayed” when the AR request has been dismissed by the user.

In an example user preference constraint, AR requests not matching user preferences may be excluded from the selected set of AR requests. User preferences may be specified for example via a User Interface (UI) comprising user preference selection controls. Any user preferences may be included. User preferences may comprise, e.g., user preferences regarding AR request types and/or user preferences regarding AR request origins. For example, a user preference may include or omit AR requests comprising business information, such as business names and hours of operation. When the user preference includes AR requests comprising business information, AR requests comprising business information may not be excluded from the selected set of AR requests. Conversely, when the user preference omits AR requests comprising business information, AR requests comprising business information may be excluded from the selected set of AR requests.

In another example, a user preference may include or omit AR requests from origins which are not pre-approved, such as AR requests received from strangers' mobile devices. When the user preference includes AR requests from origins which are not pre-approved, AR requests from unknown origins may not be excluded from the prioritized AR requests. Conversely, when the user preference omits AR requests from origins which are not pre-approved, AR requests from origins which are not pre-approved may be excluded from the prioritized AR requests. It will be appreciated with the benefit of this disclosure that embodiments may support a wide variety of user preferences, and this disclosure is not limited to the example user preferences described herein.

In an example distance constraint, AR requests comprising position information defining positions greater than a predetermined distance from the example AR device may be excluded from the selected set of AR requests. For example, AR requests comprising position information further than 20, 50, 100, or other distance from the example AR device may be excluded. In some embodiments, a distance constraint may be adaptively modified based on AR environment type. For example, when the example AR device is outside, the distance constraint may be extended to allow for AR requests comprising position information further away, while when the example AR device is inside, the distance constraint may be shortened to allow for AR requests comprising position information at shorter distances away.

In some embodiments, managing received AR requests may comprise prioritizing AR requests from a given selected set of AR requests to establish prioritized AR requests comprising higher priority and lower priority AR requests. The example AR device may be adapted to prioritize AR requests based on any prioritization criteria. For example, AR requests may be prioritized based on AR request types and/or AR request origins. In some embodiments, user prioritization preferences and/or user AR request interaction history may be used to prioritize AR requests.

In embodiments configured to prioritize AR requests based on AR request types, received AR requests may be classified by type, wherein each type may be associated with a corresponding priority value. AR requests may each be assigned the priority value of the respective type under which each respective AR request is classified. For example, AR requests may be classified by content type such as promotional, social, informational, geographical, safety, entertainment, etc. Safety related AR requests may for example have a higher priority, while promotional AR requests may have a lower priority. Thus AR requests classified as safety type AR requests may be established as higher priority, while AR requests classified as promotional type AR requests may be established as lower priority. In order to support classification of AR requests based on AR request types, AR source devices may be adapted to include type information within generated AR requests, or embodiments may configure the example AR device to make type determinations based on AR request payload information and/or other AR request data.

In embodiments configured to prioritize AR requests based on AR request origin, received AR requests may be classified by origin, e.g., by identifying a source of each AR request. Each origin, or origin type, may be associated with a corresponding priority value. AR requests may then be assigned priority values corresponding to their respective origins.

In embodiments configured to prioritize AR requests based on user prioritization preferences, the example AR device may receive user prioritization preferences, e.g., via an AR request prioritization UI adapted to receive user priority levels for different AR request types or origins. The example AR device may then prioritize received AR requests according to user-assigned priority levels.

In embodiments configured to prioritize AR requests based on user AR request interaction history, the example AR device may for example increase priority of AR request types with which the user interacts, while decreasing priority of AR request types with which the user ignores or dismisses. The example AR device may then prioritize received AR requests according to the adjusted (increased or decreased) priority levels. It will be appreciated with the benefit of this disclosure that embodiments may support a wide variety of prioritization criteria, and this disclosure is not limited to the example prioritization criteria described herein.

In some embodiments, prioritizing AR requests may comprise, e.g., performing multiple comparison operations, each comparison operation comprising: comparing a first priority associated with a first AR request with a second priority associated with a second AR request; when the first priority is higher than the second priority, placing the first AR request at a higher priority position, in the prioritized AR requests, than the second AR request; and when the second priority is higher than the first priority, placing the second AR request at a higher priority position, in the prioritized AR requests, than the first AR request. The example AR device may use such multiple comparison operations to produce a prioritized list of AR requests for each selected set of AR requests. Because the list is prioritized, the list may comprise higher and lower priority AR requests.

In some embodiments, prioritizing AR requests may comprise, e.g., comparing priorities of AR requests in the prioritized AR requests with a threshold priority, and establishing AR requests with priorities above the threshold priority among the higher priority AR requests. Meanwhile, AR requests with priorities below the threshold priority may be established among the lower priority AR requests. The example AR device may use such threshold comparison operations to produce a group of higher priority AR requests for each selected set of AR requests.

In some embodiments, managing received AR requests may comprise resolving conflicts between AR requests comprising overlapping position information. As an example of overlapping position information, two or more AR requests may include identical position information, or may include position information which is within a minimum proximity range on the AR device display, such that displayed AR request payload information could overlap should the two AR requests be simultaneously displayed by the example AR device. The example AR device may be configured to resolve conflicts between AR requests for example by adjusting display positions for conflicting AR requests, to thereby display AR request payload information for at least one conflicting AR request at an adjusted position. In some embodiments, an AR request of relatively higher priority may be displayed at its true, unadjusted position, while a conflicting AR request of relatively lower priority may be displayed at an adjusted position. In some embodiments, an AR request displayed at an adjusted position may be displayed with an arrow, or with a speech balloon type graphic, or other indicator to indicate its true, unadjusted position. In some embodiments, the example AR device may be configured to resolve conflicts between AR requests by excluding a conflicting AR request. For example, the example AR device may exclude a conflicting AR request of relatively lower priority (relative to the other conflicting AR request) from a displayed subset of the higher priority requests.

In some embodiments, managing received AR requests may comprise compiling, by the example AR device, a real-time limited subset of the higher priority requests. The real-time limited subset may include e.g., the higher priority AR requests which are displayable by the example AR device in substantially real-time. The real-time limited subset may be compiled for example by including additional AR requests in the real-time limited subset until an aggregate AR request display time exceeds a time limit for substantially real-time display.

For example, in some embodiments, the time limit for substantially real-time display may comprise any time limit up to about 2 seconds. Using an example time limit of 0.1 second, and when each AR request involves 0.01 second of processing time, 10 AR requests may be displayable by the example AR device in substantially real-time. In some embodiments, different AR requests may involve different amounts of processing time, and the individual processing times of each AR request may be added together to determine which AR requests may be included in the real-time limited subset. In other embodiments, average AR request processing times may be used.

The various AR request management operations described herein, e.g., selecting a set of AR requests, applying constraints and prioritizing AR requests, resolving conflicts, and compiling a real-time limited subset of higher priority requests, may be performed in real-time to calculate AR requests for display in each real-time view frame as viewed at the example AR device. Additionally, AR requests may expire, e.g., by expiration of a time period as may be included in each AR request, or by being displayed and subject to a “previously displayed” constraint. In some embodiments, the example AR device may be configured to expunge expired AR requests from AR request storage.

The expiration of AR requests may allow for subsequently displaying additional AR requests, e.g. AR requests beyond those included in an initial real-time limited subset of higher priority AR requests displayed at the example AR device. The example AR device may be adapted to time and/or sequence the display of additional AR requests according to priority thereof. Thus for example, the example AR device may display AR request payload information for additional AR requests within a set of prioritized AR requests, and a priority associated with each respective additional AR request may determine timing of subsequently displaying each respective additional AR request. Additional AR requests having higher priority may be displayed first, that is, first in line subsequent to expiration of one or more AR requests in the real-time limited subset of higher priority AR requests, while further additional AR requests may be displayed next, in an order according to AR request priority.

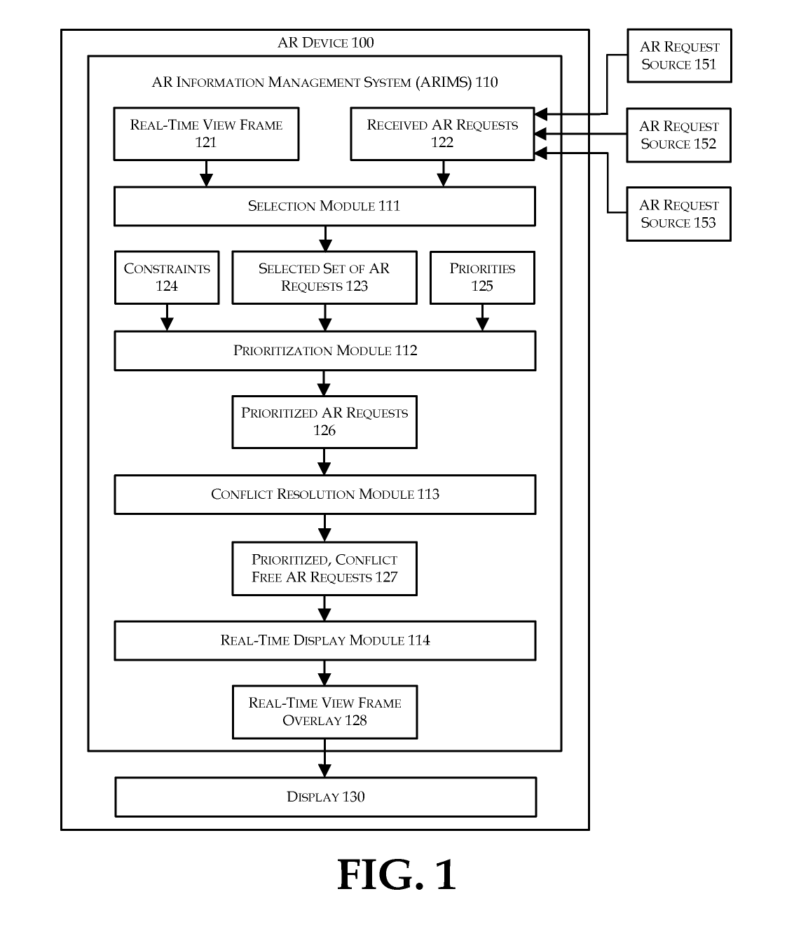

FIG. 1 is a diagram illustrating an example AR device, arranged in accordance with at least some embodiments of the present disclosure. FIG. 1 illustrates an example AR device 100 and example AR request sources 151, 152, and 153. AR device 100 comprises an AR Information Management System (ARIMS) 110 and a display 130. ARIMS 110 comprises a selection module 111, a prioritization module 112, a conflict resolution module 113, and a real-time display module 114. Data managed by ARIMS 110 includes a real-time view frame 121, received AR requests 122, a selected set of AR requests 123, constraints 124, priorities 125, prioritized AR requests 126, prioritized, conflict free AR requests 127, and a real-time view frame overlay 128.

In FIG. 1, AR device 100 may be equipped with ARIMS 110, and ARIMS 110 may adapt AR device 100 to receive, manage, and display AR requests. AR device 100 may be adapted to receive AR requests from AR request sources 151-153. Three AR request sources are illustrated as an example only, and AR device 100 may receive AR requests from more or fewer AR request sources. AR device 100 may be adapted to store received AR requests 122, e.g., in a memory at AR device 100. AR device 100 may be adapted to employ real-time view frame 121, optionally along with other information as may be used by selection module 111, prioritization module 112, conflict resolution module 113, and/or real-time display module 114, to manage and display at least subsets of AR requests 122 at display 130.

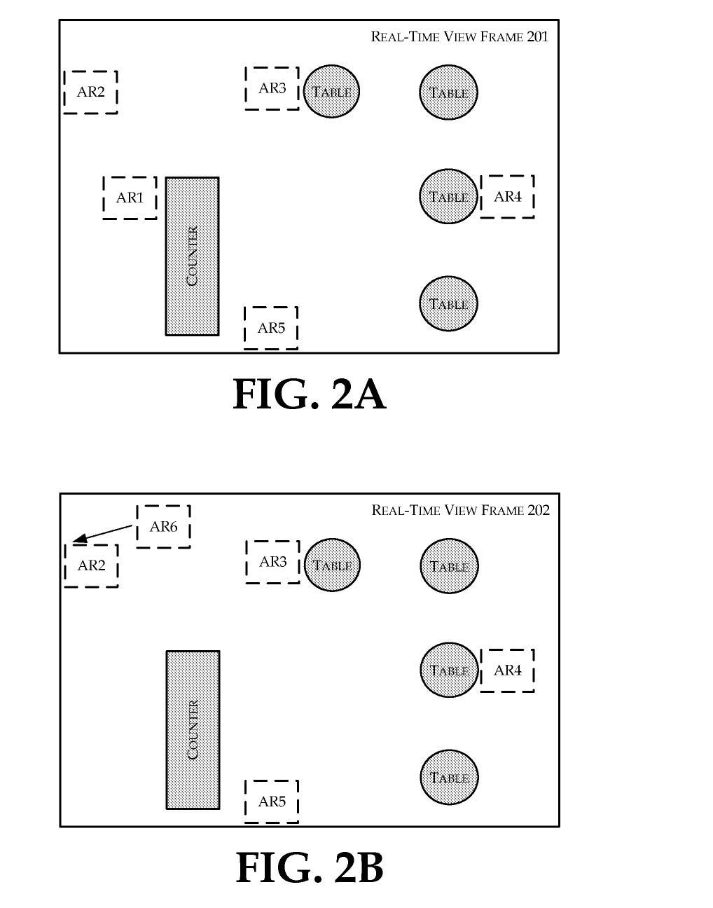

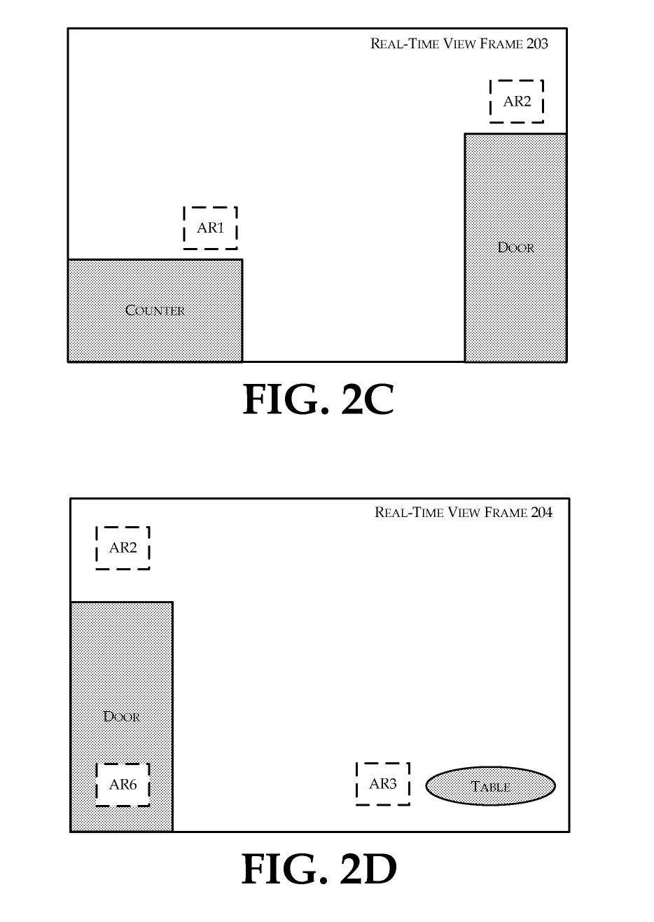

FIGS. 2A, 2B, 2C and 2D are diagrams illustrating example real-time view frames of an example AR environment, arranged in accordance with at least some embodiments of the present disclosure. Real-time view frame 121, in FIG. 1, may comprise any of real-time view frames 201, 202, 203, or 204 illustrated in FIGS. 2A-2D. Real-time view frames 201, 202, 203, and 204 comprise AR requests overlaid thereon, as a result of operation of ARIMS 110 to produce real-time view frame overlays, such as real-time view frame overlay 128, for each of real-time view frames 201, 202, 203, and 204. AR device 100 may display real-time view frames 201, 202, 203, or 204 along with appropriate real-time view frame overlays 128 at display 130. FIGS. 2A and 2B provide map views of the example AR environment, while FIGS. 2C and 2D provide elevation views of the example AR environment. In FIGS. 2A-2D, the example AR environment comprises a coffee shop, including a room equipped with a counter and tables.

AR device 100 may select AR requests for display on each of real-time view frames 201, 202, 203, and 204 according to the techniques described herein. In FIG. 2A, example AR requests AR1, AR2, AR3, AR4, and AR5 are displayed on real-time view frame 201. In FIG. 2B, example AR requests AR2-AR5 are displayed, as well as an additional AR request AR6, on real-time view frame 202. In FIG. 2C, example AR requests AR1 and AR2 are displayed on real-time view frame 203. In FIG. 2D, example AR requests AR2, AR3, and AR6 are displayed on real-time view frame 204.

In an example operation of AR device 100, received AR requests 122 may comprise, e.g., AR requests AR1-AR6, as well as any number of additional AR requests. Each of received AR requests 122 may comprise, e.g., position information that defines where, within an AR environment, AR device 100 may display the respective AR request, time information that defines a time period during which AR device 100 may display the respective AR request, and AR request payload information that defines information for display by AR device 100 within the AR environment. Each of received AR requests 122 may optionally comprise any additional information as may be desired for particular embodiments, for example, in some embodiments received AR requests 122 may comprise type information declaring type of AR request.

AR request payload information may comprise a wide variety of information, including text, image, video, and/or other information. For example, AR1 may comprise, e.g., text information comprising a temperature of a coffee cup at the counter, as may be sent by an AR request source such as a coffee maker machine or smart thermometer. AR2 may comprise, e.g., text information comprising an exit door status such as “locked” or “open” as may be sent by an AR request source such as an electronic lock. AR3 may comprise, e.g., text information comprising a message from a device user seated at the location of AR3, as may be sent by an AR request source such as a personal mobile device. AR4 and AR6 may comprise, e.g., a social networking profile pictures of device users at the locations of AR4 and AR6, respectively, as may be sent by AR request sources such as personal mobile devices. AR5 may comprise, e.g., room temperature information as may be sent by an AR request source such as a thermostat. Furthermore, received AR requests 122 may comprise any number of additional AR requests, other than AR1-AR6, and such additional AR requests may include different position information, time information, and/or AR request payload information than that of AR1-AR6.

In some embodiments, position information for AR requests 122 may comprise positions of corresponding AR request sources. For example, position information for AR1 may comprise a position of the coffee maker machine or smart thermometer. Position information for AR2 may comprise a position of the electronic lock. Position information for AR3, AR4, and AR6 may comprise positions of the personal mobile devices generating the respective AR requests. Position information for AR5 may comprise a position of the thermostat. In some embodiments, position information for AR requests 122 may comprise position information appropriate to an AR request, which may be different than AR request source position. For example, a local AR server in the coffee shop (or other AR environment), or a remote AR server, may include different position information, as appropriate, for each of a variety of different AR requests. Position information may comprise, e.g., GPS information or any other position information as appropriate.

Time information for each of AR requests 122 may comprise any time period. For example, time information for AR1 may comprise a relatively short time period, such as 1-30 seconds from a time when AR1 is generated, as may be appropriate in view of, e.g., hot coffee likely changing position and/or cooling. Time information for AR2 may comprise a relatively longer time period, such as 1-60 minutes from a time when AR2 is generated, as may be appropriate in view of likely longer intervals between changes of lock state. Time information for AR3, AR4, and AR6 may comprise intermediate time periods, such as, by way of example, 5-100 seconds from times when AR3, AR4, and AR6 are generated, or other time periods as appropriate. In some embodiments, time information may define time periods beginning after the time when an AR request is generated. For example, an AR request may define a time period beginning one minute (or any other time period) after AR request generation and ending one minute (or any other time period) thereafter.

Selection module 111 may be adapted to select selected set of AR requests 123 for display within a real-time view frame 121 comprising at least a portion of the AR environment. For example, selection module 111 may produce selected set of AR requests 123 for real-time view frame 121 comprising any of real-time view frames 201, 202, 203, or 204. Selection module 111 may be adapted to operate at least in part by taking as input a current set of AR requests 122 and a next real-time view frame 121, and producing as output a set of valid AR requests, namely, selected set of AR requests 123.

In some embodiments, selection module 111 may be arranged to employ software module(s) generally implementing pseudo-code such as:

for every AR request R in the current set of AR requests do
if R applies to a region of the next real-time view frame
then add R to the selected set of AR requests
enddo

In a first example, real-time view frame 201 may provide a first example real-time view frame of the AR environment, displayed at a time T1, and real-time view frame 202 may comprise a second real-time view frame of the AR environment, displayed at a time T2. Selection module 111 may first select a first selected set of AR requests 123 for display within real-time view frame 201, and selection module 111 may subsequently select a subsequent selected set of AR requests 123 for display within real-time view frame 202.

AR requests in each selected set of AR requests 123 may comprise position information defining positions within the respective real-time view frame 201 or 202, and time information comprising unexpired time periods at a time of each respective real-time view frame 201 or 202. For example, each of AR requests AR1-AR6 may comprise position information defining positions within the AR environment as illustrated in FIGS. 2A and/or 2B. AR requests AR1-AR5 may comprise time information comprising unexpired time periods at time T1, while AR requests AR2-AR6 may comprise time information comprising unexpired time periods at time T2. When received AR requests 122 comprise additional AR requests meeting the position and time period criteria of a particular real-time view frame, e.g., real-time view frame 201 or 202, selection module 111 may include such additional AR requests within selected set of AR requests 123.

In another example, real-time view frame 203 may comprise a first real-time view frame of the AR environment, displayed at time T1 and having a view direction V1, wherein a camera direction of AR device 100 is pointed toward the counter. Real-time view frame 204 may comprise a second real-time view frame of the AR environment, displayed at time T2 and having a view direction V2, wherein a camera direction of AR device 100 is pointed toward the table proximal to AR3. Selection module 111 may first select selected set of AR requests 123 for display within real-time view frame 203, and selection module 111 may subsequently select selected set of AR requests 123 for display within real-time view frame 204.

AR requests in each selected set of AR requests 123 may comprise position information defining positions within the respective real-time view frame 203 or 204, and time information comprising unexpired time periods at a time of each respective real-time view frame 201 or 202. For example, each of AR requests AR1-AR2 may comprise position information defining positions within the portion of AR environment illustrated in real-time view frame 203, and each of AR requests AR2, AR3, and AR6 may comprise position information defining positions within the portion of AR environment illustrated in real-time view frame 204. Additionally, AR requests AR1-AR2 may comprise time information comprising unexpired time periods at time T1, while AR requests AR2, AR3, and AR6 may comprise time information comprising unexpired time periods at time T2. As noted herein, when received AR requests 122 comprise additional AR requests meeting the position and time period criteria of a particular real-time view frame, e.g., real-time view frame 203 or 204, selection module 111 may include such additional AR requests within selected set of AR requests 123.

Prioritization module 112 may be adapted to prioritize AR requests to thereby establish higher priority and lower priority AR requests. For example, prioritization module 112 may be adapted to take, as input: selected set of AR requests 123; constraints 124; and priorities 125. Prioritization module 112 may be adapted to produce, as output: prioritized AR requests 126, comprising, e.g., an ordered set of AR requests, in order of AR request priority.

In some embodiments, constraints 124 and priorities 125 may comprise default constraints and priorities, respectively, which may be predetermined for use by ARIMS 110 and may optionally be updated from time to time. In some embodiments, constraints 124 and priorities 125 may comprise constraints and priorities assigned by a user of AR device 100. For example, ARIMS 110 may provide a UI adapted to receive user constraints, such as “never display promotional AR requests”, “never display AR requests of unknown origin” or any other user constraints. ARIMS 110 may provide a UI adapted to receive user priorities, such as by including user priority adjustment controls to adjust priority levels for AR requests of different types, e.g., safety-related AR requests, personal communication AR requests, etc. In some embodiments, ARIMS 110 may be adapted to dynamically update constraints 124 and priorities 125 based on user history. For example, AR requests with which a user interacts, such as by selecting an AR request, responding to a message in an AR request, or zooming in on an AR request, may be weighted as higher priority than AR requests which a user ignores or dismisses.

In some embodiments, prioritization module 112 may comprise two subparts. A first subpart may be arranged to implement a set of constraints 124 to eliminate one or more AR requests, and a second subpart may be arranged to prioritize remaining AR requests according to priorities 125.

The first subpart may employ software module(s) generally implementing pseudo-code such as the following, wherein initially all of selected set of AR requests 123 may be included in prioritized AR requests 126, and subsequently certain AR requests may be excluded from prioritized AR requests 126:

for every AR request R in prioritized AR requests do
for every constraint C in the set of constraints do
   if C applies to R
   then exclude R from prioritized AR requests
enddo

enddo

In some embodiments, prioritization module 112 may be adapted to apply one or more constraints 124 to exclude one or more AR requests from selected set of AR requests 123, in connection with generating prioritized AR requests 124. Constraints 124 may comprise, e.g., “previously displayed” constraints, user preference constraints, and/or distance constraints as described herein.

The second subpart of prioritization module 112 may employ software module(s) generally implementing pseudo-code such as the following, to produce, e.g., an ordered list of prioritized AR requests within prioritized AR requests 124:

repeat
for every pair (R1,R2) of AR requests in prioritized AR requests do
   for every priority P in a set of priorities do
      set P1=the highest priority that can be associated with R1
      set P2=the highest priority that can be associated with R2
      if P1<P2 then place R1 before R2 in list of prioritized AR
   requests
      else place R2 before R1 in list of prioritized AR requests
   enddo
enddo

until no more changes can be made in list of prioritized AR requests

In some embodiments, prioritization module 112 may be adapted to prioritize AR requests by performing multiple comparison operations, each comparison operation comprising: comparing a first priority associated with a first AR request with a second priority associated with a second AR request; when the first priority is higher than the second priority, placing the first AR request at a higher priority position, in prioritized AR requests 126, than the second AR request; and when the second priority is higher than the first priority, placing the second AR request at a higher priority position, in prioritized AR requests 126, than the first AR request.

It will be appreciated with the benefit of this disclosure that prioritization module 112 may prioritize AR requests according to a wide range of different techniques. This disclosure is not limited to any particular prioritization technique. In some embodiments, prioritization module 112 may be adapted to simultaneously accommodate multiple priorities which may (or may not) overlap. Priorities may be weighted, and prioritization module 112 may be adapted to assign cumulative weighted priority values to each AR request in prioritized AR requests 126. In some embodiments, prioritization module 112 may be adapted to compare priorities of AR requests in prioritized AR requests 126 with a threshold priority, and establish AR requests with priorities above the threshold priority among higher priority AR requests. Prioritization module 112 may for example exclude AR requests with priorities below the threshold priority from prioritized AR requests 126, or may establish AR requests with priorities below the threshold priority as lower priority AR requests. The use of a threshold priority may optionally eliminate nuanced determinations of relative AR request priority and may thereby increase processing speed in some embodiments.

In some embodiments, prioritization module 112 may be adapted to assign priorities to AR requests based on AR request types. For example, prioritization module 112 may classify AR requests according to types, such as: urgent safety, non-urgent safety, personal communication from contact, personal communication from stranger, informational, promotional, or any number of other types. Prioritization module 112 may apply, to each respective AR request, a priority associated with an AR request type under which the respective AR request may be classified.

In an example based on FIG. 2A-2B, prioritized AR requests 126 output by prioritization module 112 may comprise higher priority AR requests AR1-AR5 for real-time view frame 201 as shown in FIG. 2A, as well as any number of additional, lower priority AR requests other than AR1-AR5. Prioritized AR requests 126 output by prioritization module 112 may comprise higher priority AR requests AR2-AR6 for real-time view frame 202 as shown in FIG. 2B, as well as any number of additional, lower priority AR requests other than AR2-AR6. Furthermore, prioritized AR requests 126 for real-time view frames 201 or 202 may also comprise any number of additional higher priority AR requests, other than AR1-AR5 or AR2-AR6 which additional higher priority AR requests may nonetheless not be displayed in real-time view frames 201 or 202, due to operations of conflict resolution module 113 and/or real-time display module 114, as described herein.

In an example based on FIG. 2C-2D, prioritized AR requests 126 output by prioritization module 112 may comprise higher priority AR requests AR1-AR2 for real-time view frame 203 as shown in FIG. 2C, as well as any number of additional, lower priority AR requests other than AR1-AR2. Prioritized AR requests 126 output by prioritization module 112 may comprise higher priority AR requests AR2, AR3, and AR6 for real-time view frame 204 as shown in FIG. 2D, as well as any number of additional, lower priority AR requests other than AR2, AR3, and AR6. Furthermore, prioritized AR requests 126 for real-time view frames 203 or 204 may also comprise any number of additional higher priority AR requests, other than AR1-AR2 (for real-time view frame 203) or AR2, AR3, and AR6 (for real-time view frame 204) which additional higher priority AR requests may nonetheless not be displayed in real-time view frames 203 or 204, due to operations of conflict resolution module 113 and/or real-time display module 114, as described herein.

Conflict resolution module 113 may be adapted to resolve conflicts between AR requests comprising overlapping position information. In some embodiments, conflict resolution module 113 may take prioritized AR requests 126 as input, and conflict resolution module 113 may produce prioritized, conflict-free AR requests 127 as output. Conflict resolution module 113 may for example adjust display positions of conflicting AR requests within prioritized AR requests 126, to thereby include position-adjusted AR requests in prioritized, conflict-free AR requests 127. AR device 100 may display AR request payload information for position-adjusted AR requests at their corresponding adjusted positions, while optionally including an arrow or other visual indication of original AR request position. Alternatively, conflict resolution module 113 may exclude conflicting AR requests from prioritized AR requests 126, so that prioritized, conflict-free AR requests 127 includes a reduced set of AR requests.

In some embodiments, conflict resolution module 113 may be arranged to employ software module(s) generally implementing pseudo-code such as the following, wherein initially all of prioritized AR requests 126 may be included in prioritized, conflict-free AR requests 127, and subsequently certain AR requests may be excluded from prioritized, conflict-free AR requests 127:

repeat
for every pair (R1,R2) of AR requests initially included in prioritized, conflict-free AR requests do
   if AR request payload information for R1 and R2 occupy a same area of the display (and R1 precedes R2 in the prioritized AR requests) [a conflict is identified]
   then attempt to find a different position on the display to overlay the AR request payload information for R2
   if no such position is found
   then eliminate R2 from prioritized, conflict-free AR requests
enddo

until no more conflicts are identified in prioritized, conflict-free AR requests

In an example based on FIG. 2B, prioritized AR requests 126 output by prioritization module 112 may comprise both AR2 and AR6 for real-time view frame 202 as shown in FIG. 2B. AR requests AR2 and AR6 may comprise proximal or similar position information within real-time view frame 202, such that AR request payload information for AR2 and AR6 would overlap. Conflict resolution module 113 may be adapted to adjust display position of AR2 or AR6 to prevent overlapping AR request payload information within real-time view frame 202. In some embodiments, conflict resolution module 113 may adjust display position of the AR request having the lower priority, e.g., AR6.

In an example based on FIG. 2D, AR request payload information for AR2 and AR6 do not overlap within real-time view frame 204, as real-time view frame 204 comprises an elevation rather than a map view of the AR environment. Therefore conflict resolution module 113 need not adjust position or eliminate AR2 or AR6. However, in the event that prioritized AR requests 126 for real-time view frame 204 includes any number of additional AR requests having positions overlapping those of AR2, AR3, and/or AR6 conflict resolution module 113 may eliminate such conflicting AR requests from prioritized, conflict-free AR requests 127 for real-time view frame 204.

Real-time display module 114 may be adapted to prepare real-time view frame overlay 128 for the next real-time view frame to be displayed at display 130. Real-time display module 114 may for example take prioritized, conflict-free AR requests 127 as input, and may output real-time view frame overlay 128, comprising a real-time limited subset of higher priority AR requests ready for display 130.

In some embodiments, real-time display module 114 may be arranged to employ software module(s) generally implementing pseudo-code such as the following:

set L=total time limit to display real-time view frame overlay over the next frame in order to maintain substantially real-time display

set t=0; done=false; real-time view frame overlay={ }
repeat
   set R=next AR request in prioritized, conflict-free AR requests
   set tR=time needed to display AR request payload information for R if t+tR<L
      then set t=t+tR; add R to real-time view frame overlay
      else done=true
until done or no next AR request in prioritized, conflict-free AR requests

In some embodiments, the real-time display module 114 may omit the above “else” line. Real-time display module 114 may thereby be adapted to include lower priority AR requests in real-time view frame overlay 128, so long as such lower priority AR requests, combined, take less time to display than the remaining time under time limit L.

In some embodiments, real-time display module 114 may compile real-time view frame overlay 128 comprising a real-time limited subset of higher priority AR requests. Real-time display module 114 may include additional AR requests, e.g., from prioritized, conflict-free AR requests 127, in the real-time limited subset until an aggregate AR request display time exceeds a time limit for substantially real-time display. The time limit for substantially real-time display may comprise any selected time limit, e.g. any time limit up to about 2 seconds as disclosed herein.

In some embodiments, ARIMS 110 may be adapted to apply time limits to run each of modules 111, 112, 113, and 114, in order to complete the entire preparation real-time view frame overlay 128 in real time. As such, optimization or truncation techniques can be used to ensure the best performance (even if suboptimal) of ARIMS 110 within available time and computational resources. As more devices communicate AR requests, the number of AR requests available for overlay on real-time view frames may exceed the capabilities of AR device displays. As such, real-time display module 114 may be adapted to ensure real-time view frame overlays can be displayed in substantially real-time, that is, in sufficiently short time that real-time view frame overlays appear to the user to be displayed in real-time over the next real-time view frame.

In examples based on FIGS. 2A-2B and 2C-2D, real-time display module 114 may eliminate, from prioritized, conflict-free AR requests 127 for each of real-time view frames 201, 202, 203, and 204, all AR requests other than those shown in each of real-time view frames 201, 202, 203, and 204, respectively. Real-time view frame overlay 128 for real-time view frame 201 may therefore comprise AR1-AR5. Real-time view frame overlay 128 for real-time view frame 202 may comprise AR2-AR6. Real-time view frame overlay 128 for real-time view frame 203 may comprise AR1-AR2. Real-time view frame overlay 128 for real-time view frame 204 may comprise AR2, AR3, and AR6.

When real-time view frame overlay 128 is finalized, AR device 100 may be adapted to display real-time view frame overlay 128 over real-time view frame 121 for which real-time view frame overlay 128 was calculated. Real-time view frame overlay 128 may comprise AR request payload information for each of the AR requests included in real-time view frame overlay 128, that is, a real-time limited subset of AR requests displayable by AR device 100 in substantially real-time.

In an example based on FIG. 2A, real-time view frame overlay 128 for real-time view frame 201 may comprise AR1-AR5, at positions as illustrated in FIG. 2A. The real-time limited subset of AR requests displayable by AR device 100 in substantially real-time, along with real-time view frame 201, may therefore comprise AR1-AR5. Similarly, for FIGS. 2B, 2C, and 2D, real-time view frame overlay 128 for each of real-time view frames 202, 203, and 204, respectively, may comprise [AR2-AR6], [AR1-AR2], and [AR2, AR3, and AR6], respectively.

In some embodiments, AR device 100 may be adapted to subsequently display AR request payload information for additional AR requests, e.g., AR requests other than those which may be initially displayed within an AR environment. In an example based on FIGS. 2A-2B, AR device 100 may initially display AR1-AR5 in real-time view frame 201, and AR device 100 may subsequently display AR request payload information for AR6 in real-time view frame 202. AR6 may comprise, e.g., an AR request within prioritized AR requests 126 and/or within prioritized, conflict free AR requests 127 for real-time view frame 201, however AR6 may have been ultimately eliminated from real-time view frame overlay 128 for real-time view frame 201. AR6 may next be included in prioritized AR requests 126 and prioritized, conflict free AR requests 127 for subsequent real-time view frame 202, and AR6 may be included in real-time view frame overlay 128 for real-time view frame 202. AR device 100 may therefore subsequently display AR request payload information for additional AR request. AR device 100 may similarly display further additional AR requests subsequent to real-time view frame 202. AR6, and further additional AR requests, may be displayed in order of priority so that a priority associated with each respective additional AR request determines timing of subsequently displaying each respective additional AR request.

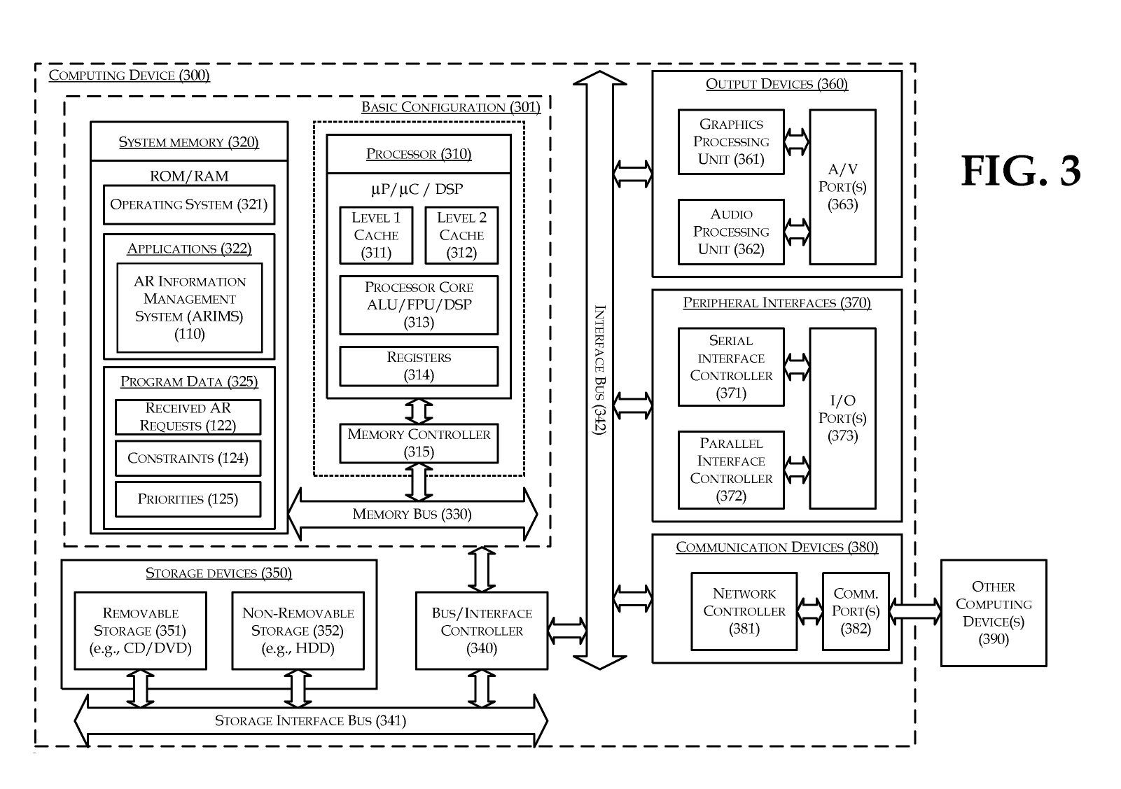

FIG. 3 is a block diagram of a computing device 300 as one example of an AR device, arranged in accordance with at least some embodiments of the present disclosure. In a very basic configuration 301, computing device 300 may include one or more processors 310 and system memory 320. A memory bus 330 may be used for communicating between the processor 310 and the system memory 320.

Depending on the desired configuration, processor 310 may be of any type including but not limited to a microprocessor (μP), a microcontroller (μC), a digital signal processor (DSP), or any combination thereof. Processor 310 may include one or more levels of caching, such as a level one cache 311 and a level two cache 312, a processor core 313, and registers 314. The processor core 313 may include an arithmetic logic unit (ALU), a floating point unit (FPU), a digital signal processing core (DSP Core), or any combination thereof. A memory controller 315 may also be used with the processor 310, or in some implementations the memory controller 315 may be an internal part of the processor 310.

Depending on the desired configuration, the system memory 320 may be of any type including but not limited to volatile memory (such as RAM), non-volatile memory (such as ROM, flash memory, etc.), or any combination thereof. System memory 320 typically includes an operating system 321, one or more applications 322, and program data 325. In some embodiments, operating system 321 may comprise a virtual machine that is managed by a Virtual Machine Manager (VMM). Applications 322 may include, for example, ARIMS module(s) 110. Program data 325 may include received AR requests 122, constraints 124, and priorities 125, along with any other data that may be used by applications 322.

Computing device 300 may have additional features or functionality, and additional interfaces to facilitate communications between the basic configuration 301 and any required devices and interfaces. For example, a bus/interface controller 340 may be used to facilitate communications between the basic configuration 301 and one or more data storage devices 350 via a storage interface bus 341. The data storage devices 350 may be removable storage devices 351, non-removable storage devices 352, or a combination thereof. Examples of removable storage and non-removable storage devices include magnetic disk devices such as flexible disk drives and hard-disk drives (HDD), optical disc drives such as compact disc (CD) drives or digital versatile disc (DVD) drives, solid state drives (SSD), and tape drives, to name a few. Example computer storage media may include volatile and nonvolatile, removable and non-removable media implemented in any method or technology for storage of information, such as computer readable instructions, data structures, program modules, or other data.

Level 1 cache 311, level 2 cache 312, system memory 320, removable storage 351, and non-removable storage devices 352 are all examples of computer storage media. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium that may be used to store the desired information and that may be accessed by computing device 300. Any such computer storage media may be part of device 300.

Computing device 300 may also include an interface bus 342 for facilitating communication from various interface devices (e.g., output interfaces, peripheral interfaces, and communication interfaces) to the basic configuration 301 via the bus/interface controller 340. Example output devices 360 include a graphics processing unit 361 and an audio processing unit 362, which may be configured to communicate to various external devices such as a display or speakers via one or more AN ports 363. Example peripheral interfaces 370 may include a serial interface controller 371 or a parallel interface controller 372, which may be configured to communicate through either wired or wireless connections with external devices such as input devices (e.g., keyboard, mouse, pen, voice input device, touch input device, etc.) or other peripheral devices (e.g., printer, scanner, etc.) via one or more I/O ports 373. Other conventional I/O devices may be connected as well such as a mouse, keyboard, and so forth. An example communications device 380 includes a network controller 381, which may be arranged to facilitate communications with one or more other computing devices 390 over a network communication via one or more communication ports 382.

The computer storage media may be one example of a communication media. Communication media may typically be embodied by computer readable instructions, data structures, program modules, or other data in a modulated data signal, such as a carrier wave or other transport mechanism, and include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media.

Computing device 300 may be implemented as a mobile device. Computing device 300 may also be implemented as head-mounted AR device such as glasses or goggles adapted to overlay AR information on views of the physical world. Computing device 300 may also be implemented as a personal or business use computer including both laptop computer and non-laptop computer configurations.

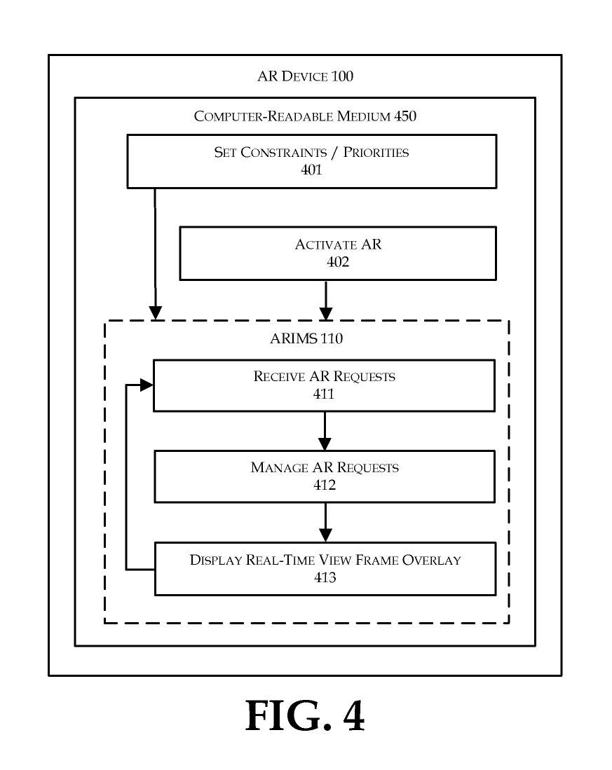

FIG. 4 is a flow diagram illustrating an example AR information management method, arranged in accordance with at least some embodiments of the present disclosure. The example flow diagram may include one or more operations/modules as illustrated by blocks 401, 402, 411, 412, and 413, which represent operations as may be performed in a method, functional modules in an AR device 100, and/or instructions as may be recorded on a computer readable medium 450. The illustrated blocks 401 and 402 may include user interactions with AR device 100 and/or ARIMS 110, while the illustrated blocks 411, 412, and 413 may include functional operations of ARIMS 110.

In FIG. 4, blocks 401, 402, 411, 412, and 413 are illustrated as including blocks being performed sequentially, e.g., with block 401 first and block 413 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 4 illustrates an example method by which AR device 100 may set priorities and constraints, activate AR, and continuously receive, manage, and display AR requests while AR is active. At a “Set Constraints/Priorities” block 401, AR device 100 may set AR request display constraints and/or priorities. For example, in some embodiments a user may interact with a UI provided by ARIMS 110. A constraints UI may allow the user to set AR request exclusion rules, so that ARIMS 110 excludes, from real-time view frame overlays, AR requests having user-identified properties. A priorities UI may allow the user to set AR request priorities, so that ARIMS 110 prioritizes AR requests according to priority settings. In some embodiments, ARIMS 110 may be pre-configured with a set of constraints and priorities. In some embodiments, ARIMS 110 may automatically adjust constraints and/or priorities based on user AR interaction history. Block 401 may be followed by block 402.

At an “Activate AR” block 402, AR device 100 may activate operation of ARIMS 110, e.g., in response to user selection of an AR application or function at AR device 100. AR device 100 may initiate ARIMS 110 to begin receiving and overlaying AR requests on real-time view frames visible at AR device 100. Block 402 may be followed by operation of ARIMS 110, including blocks 411, 412, and 413.

At a “Receive AR Requests” block 411, AR device 100 may receive AR requests from AR request sources, such as AR request sources 151-153, illustrated in FIG. 1. In some embodiments, AR device 100 may engage in AR device discovery to discover surrounding peer devices, proximal AR servers, available remote AR servers, and/or other AR request sources. AR device 100 may optionally notify AR request sources of information such as AR device 100 identity, user identity, and/or AR request preferences. AR device 100 may then begin and continue receiving AR requests from AR request sources as AR requests are generated and sent from AR request sources. Block 411 may be followed by block 412.

At a “Manage AR Requests” block 412, AR device 100 may manage AR requests received at block 411, to determine which received AR requests to overlay on real-time view frames viewed at AR device 100. AR device 100 may for example employ modules 111-114 of ARIMS 110, as described with reference to FIG. 1. In some embodiments, block 412 may be performed substantially continuously as real-time view frames change and/or as new AR requests are received and old AR requests expire. In some embodiments, AR device 100 may manage AR requests at block 412 so that priorities associated with each respective additional AR request determines timing of subsequently displaying each respective additional AR request, as described herein. Block 412 may be followed by block 413.

At a “Display Real-Time View Frame Overlay” block 413, AR device 100 may display real-time view frame overlays, comprising AR requests selected at block 412, for each new real-time view frame viewed at AR device 100. AR requests in a real-time view frame overlay may be displayed according to the techniques described herein, at or near their respective positions in an AR environment, e.g., as illustrated in FIGS. 2A-2D. Depending on AR device type, AR device 100 may simultaneously display both real-time view frames and real-time view frame overlays, e.g., in the case of a smart phone displaying a live camera feed along with real-time view frame overlays, or AR device 100 may display real-time view frame overlays on a transparent lens through which an AR environment is viewed, e.g., in embodiments comprising AR glasses or goggles. Block 413 may be followed by block 411, so that blocks 411-413 operate in a continuous loop, or in some embodiments, blocks 411-413 may operate continuously and simultaneously.

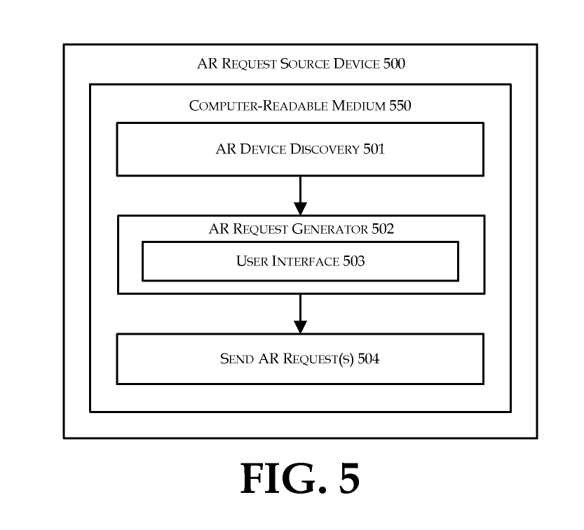

FIG. 5 is a diagram illustrating an example AR request source device and method to generate AR requests, arranged in accordance with at least some embodiments of the present disclosure. The diagram includes an AR request source device 500, a computer readable medium 550, and operations/modules as illustrated by blocks 501, 502, 503, and 504, which represent operations as may be performed in a method, functional modules in AR request source device 500, and/or instructions as may be recorded on computer readable medium 550.

In FIG. 5, blocks 501, 502, 503, and 504 are illustrated as including blocks being performed sequentially, e.g., with block 501 first and block 504 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 5 illustrates an example method by which AR request source device 500 may discover AR devices, generate AR requests, and send generated AR requests to the discovered AR devices. AR request source device 500 may comprise any of the various AR request sources described herein, or other AR request sources arranged in accordance with this disclosure. To provide just a few examples, AR request source device 500 may comprise a personal mobile device adapted to provide AR requests to proximal AR devices, a local AR server adapted to provide AR requests to proximal AR devices, a remote AR server adapted to provide AR requests to AR devices in response, e.g., in response to requests from AR devices, a vehicle based device adapted to provide AR requests to proximal AR devices, or a smart sensor or smart appliance such as a thermometer, thermostat, refrigerator, coffee maker, etc. In some embodiments, AR request source device 500 may comprise a device which is also equipped to serve as an AR device.

At an “AR Device Discovery” block 501, AR request source device 500 may discover AR devices available to receive AR requests, optionally along with additional information for each discovered AR device, such as AR device identity, AR device user identity, AR device position, and/or AR request preferences. For example, AR request source device 500 may broadcast a localized wireless discovery signal and AR request source device 500 may listen for responses from any proximal AR devices. AR request source device 500 may exchange further handshake information with any responding AR devices. When AR request source device 500 comprises a remote AR server, AR request source device 500 may receive incoming communications from AR devices, and AR request source device 500 may exchange further handshake information with any AR devices that initiate communication with AR request source device 500. In some embodiments, block 501 may be omitted, and AR request source device 500 may generate and broadcast AR requests, e.g., using blocks 502 and 503, for receipt by any AR devices equipped to receive such broadcasted AR requests. Block 501 may be followed by block 502.

At an “AR Request Generator” block 502, AR request source device 500 may generate AR requests. Generated AR requests may generally comprise any AR request properties described herein, e.g., position information, time information, AR request payload information, type information, and/or any other information as may be employed to support additional functions or features in the spirit of this disclosure.

When AR request source device 500 comprises a mobile device, and position information comprises a current position of the mobile device, AR request source device 500 may determine its real-time position at block 502, e.g., by retrieving GPS position or other position coordinates, and AR request source device 500 may include its real-time position in generated AR requests. When an AR request is associated with an object other than AR request source device 500, AR request source device 500 may determine the position of such object for inclusion in generated AR requests.

To generate time information for AR requests, AR request source device 500 may, e.g., add a predetermined time period for an AR request to a current clock time at which the AR request is generated. The predetermined time period may vary based on the type of AR request, e.g., some AR requests may be relevant for short periods of time such as several seconds, while other AR requests may be relevant for longer periods of time such as several hours. In some embodiments, time information may comprise future starting and ending times, e.g., a relevancy period beginning in one minute from current time, and ending in two minutes from current time.

To generate AR request payload information for AR requests, AR request source device 500 may, e.g., combine any static AR request payload information, which may be identical for all AR requests of a particular type, with any dynamic AR request payload information, which may be gathered by AR request source device 500 in real-time. For example, AR requests comprising vehicle information may combine static vehicle description information with dynamic information such as vehicle speed. AR requests comprising lock state information may comprise static text or image information describing a door with dynamic information describing whether the door is locked or unlocked. AR requests comprising social media status updates or profile information may comprise static user identity information with dynamic status update or profile information.

In some embodiments, block 502 may comprise a “User Interface (UI)” block 503. AR request source device 500 may employ UI 503 to interact with a user at AR request source device 500. The user may optionally supply any AR request properties for inclusion in generated AR requests. For example, the user may supply AR request payload information such as pictures and/or text communications, e.g., via a field or file selection control included in UI 503. The user may also optionally supply time and/or position information for AR requests in some embodiments. In some embodiments, the user may optionally initiate sending AR requests from UI 503. In some embodiments, block 502 may interact with UI provided by other applications at AR request source device 500. For example, a social media application may provide UI 503, wherein UI 503 may be adapted to post a social media status update or picture, and UI 503 may furthermore be adapted to simultaneously include such social media status update or picture in an AR request. Block 502 may be followed by block 503.

At a “Send AR Request(s)” block 503, AR request source device 500 may send AR request(s) generated at block 502. AR requests may be sent using any available wired or wireless communication techniques, as will be appreciated by those of skill in the art. In some embodiments, generated AR requests may be sent to all AR devices discovered at block 501. In some devices, AR request source device 500 may send generated AR requests to a limited set of one or more AR devices, e.g., by sending generated AR requests to Internet Protocol (IP) addresses corresponding to the limited set of AR devices. In some embodiments, the limited set of AR devices may comprise, e.g., AR devices which supplied preference information, at block 501, indicating a preference for AR requests of a type matching a generated AR request. In some embodiments, the limited set of AR devices may comprise AR devices identified by a user of AR request source device 500, e.g., via UI 503. In some embodiments, the limited set of AR devices may comprise AR devices on a list of personal contacts at AR request source device 500. Any other approach may be used to supply AR requests to limited sets of AR devices as will be appreciated.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disc (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely examples and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly inter-actable and/or wirelessly interacting components and/or logically interacting and/or logically inter-actable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. An Augmented Reality (AR) information management method comprising:
receiving, by a computing device, a plurality of AR information display requests (AR requests), wherein each AR request comprises:
position information that defines where, within an AR environment, the computing device may display the AR request;
time information that defines a time period during which the computing device may display the AR request; and
AR request payload information that defines information for display by the computing device within the AR environment;
selecting, by the computing device, for display within a real-time view frame comprising at least a portion of the AR environment, a selected set of AR requests, wherein AR requests in the selected set of AR requests comprise:
position information defining positions within the real-time view frame; and
time information comprising unexpired time periods;
prioritizing AR requests in the selected set of AR requests, by the computing device, to thereby establish prioritized AR requests comprising higher priority and lower priority AR requests; and
displaying, by the computing device, within the real-time view frame, AR request payload information for at least a subset of the higher priority AR requests within the prioritized AR requests, wherein the displayed subset of the higher priority AR requests comprises a real-time limited subset displayable by the computing device in substantially real-time.

2. The AR information management method of claim 1, further comprising subsequently displaying, by the computing device, AR request payload information for one or more additional AR requests within the prioritized AR requests, wherein a priority associated with each respective additional AR request determines timing of subsequently displaying each respective additional AR request.

3. The AR information management method of claim 1, further comprising applying, by the computing device, one or more constraints to exclude one or more AR requests from the prioritized AR requests.

4. The AR information management method of claim 3, wherein at least one constraint comprises one or more of:
a “previously displayed” constraint whereby one or more AR requests for which AR request payload information has been previously displayed are excluded from the prioritized AR requests;
a user preference constraint whereby one or more AR requests not matching user preferences are excluded from the prioritized AR requests; or
a distance constraint whereby one or more AR requests comprising position information defining positions greater than a predetermined distance from the computing device are excluded from the prioritized AR requests.

5. The AR information management method of claim 1, wherein prioritizing AR requests comprises assigning priorities to AR requests based on AR request types.

6. The AR information management method of claim 1, wherein prioritizing AR requests comprises performing multiple comparison operations, each comparison operation comprising:
comparing a first priority associated with a first AR request with a second priority associated with a second AR request;
when the first priority is higher than the second priority, placing the first AR request at a higher priority position, in the prioritized AR requests, than the second AR request; and
when the second priority is higher than the first priority, placing the second AR request at a higher priority position, in the prioritized AR requests, than the first AR request.

7. The AR information management method of claim 1, wherein prioritizing AR requests comprises:
comparing priorities of AR requests in the prioritized AR requests with a threshold priority; and
establishing AR requests with priorities above the threshold priority among the higher priority AR requests.

8. The AR information management method of claim 1, wherein displaying, within the real-time view frame, the AR request payload information comprises displaying each respective AR request payload information according to position information associated with each respective AR request, and further comprising resolving, by the computing device, one or more conflicts between AR requests comprising overlapping position information, wherein resolving at least one conflict comprises:
adjusting a display position for a conflicting AR request, to thereby display AR request payload information for the conflicting AR request at an adjusted position; or
excluding the conflicting AR request from the displayed subset of the higher priority AR requests.

9. The AR information management method of claim 1, further comprising compiling, by the computing device, the real-time limited subset of the higher priority AR requests by including additional AR requests in the real-time limited subset until an aggregate AR request display time exceeds a time limit for substantially real-time display.

10. The AR information management method of claim 1, wherein the AR requests comprise one or more of:
AR requests from one or more mobile computing devices proximal to the computing device;
AR requests from one or more vehicle-based computing devices proximal to the computing device, comprising one or more of vehicle status or road condition AR request payload information;
AR requests from one or more environmental sensors proximal to the computing device; or
AR requests from one or more remote AR servers adapted to provide the AR requests based on a location of the computing device or information detected through a camera at the computing device.

11. A non-transitory computer readable storage medium having computer executable instructions executable by a processor, the instructions that, when executed by the processor, cause the processor to:
receive a plurality of Augmented Reality information display requests (AR requests), wherein each AR request comprises:
position information that defines where, within an AR environment, the computing device may display the AR request;
time information that defines a time period during which the computing device may display the AR request; and
AR request payload information that defines information for display by the computing device within the AR environment;
select, for display within a real-time view frame comprising at least a portion of the AR environment, a selected set of AR requests, wherein AR requests in the selected set of AR requests comprise:
position information defining positions within the real-time view frame; and
time information comprising unexpired time periods;
prioritize AR requests in the selected set of AR requests to thereby establish prioritized AR requests comprising higher priority and lower priority AR requests; and
display, within the real-time view frame, AR request payload information for at least a subset of the higher priority AR requests within the prioritized AR requests, wherein the displayed subset of the higher priority AR requests comprises a real-time limited subset displayable by the computing device in substantially real-time.

12. The non-transitory computer readable storage medium of claim 11, further comprising instructions that cause the processor to subsequently display AR request payload information for one or more additional AR requests within the prioritized AR requests, wherein a priority associated with each respective additional AR request determines timing of subsequently displaying each respective additional AR request.

13. The non-transitory computer readable storage medium of claim 11, further comprising instructions that cause the processor to apply one or more constraints to exclude one or more AR requests from the prioritized AR requests.

14. The non-transitory computer readable storage medium of claim 11, wherein the instructions that cause the processor to display, within the real-time view frame, the AR request payload information comprise instructions that cause the processor to display each respective AR request payload information according to position information associated with each respective AR request, and further comprising instructions that cause the processor to resolve one or more conflicts between AR requests comprising overlapping position information, wherein resolving at least one conflict comprises:
adjusting a display position for a conflicting AR request, to thereby display AR request payload information for the conflicting AR request at an adjusted position; or
excluding the conflicting AR request from the displayed subset of the higher priority AR requests.

15. The non-transitory computer readable storage medium of claim 11, further comprising instructions that cause the processor to compile the real-time limited subset of the higher priority AR requests by including additional AR requests in the real-time limited subset until an aggregate AR request display time exceeds a time limit for substantially real-time display.

16. A computing device comprising:
a processor;
a memory; and
an Augmented Reality (AR) information manager stored in the memory and executable by the processor, wherein the AR information manager is configured to:
receive a plurality of AR information display requests (AR requests), wherein each AR request comprises:
position information that defines where, within an AR environment, the computing device may display the AR request;
time information that defines a time period during which the computing device may display the AR request; and
AR request payload information that defines information for display by the computing device within the AR environment;
select, for display within a real-time view frame comprising at least a portion of the AR environment, a selected set of AR requests, wherein requests in the selected set of AR requests comprise:
position information defining positions within the real-time view frame; and
time information comprising unexpired time periods;
prioritize AR requests in the selected set of AR requests to thereby establish prioritized AR requests comprising higher priority and lower priority AR requests; and
display, within the real-time view frame, AR request payload information for at least a subset of the higher priority AR requests within the prioritized AR requests, wherein the displayed subset of the higher priority AR requests comprises a real-time limited subset displayable by the computing device in substantially real-time.

17. The computing device of claim 16, wherein the AR information manager is configured to subsequently display AR request payload information for one or more additional AR requests within the prioritized AR requests, wherein a priority associated with each respective additional AR request determines timing of subsequently displaying each respective additional AR request.

18. The computing device of claim 16, wherein the AR information manager is configured to apply one or more constraints to exclude one or more AR requests from the prioritized AR requests.

19. The computing device of claim 16, wherein the AR information manager is configured to display, within the real-time view frame, the AR request payload information by displaying each respective AR request payload information according to position information associated with each respective AR request, and wherein the AR information manager is configured to resolve one or more conflicts between AR requests comprising overlapping position information, wherein resolving at least one conflict comprises:
adjusting a display position for a conflicting AR request, to thereby display AR request payload information for the conflicting AR request at an adjusted position; or
excluding the conflicting AR request from the displayed subset of the higher priority AR requests.

20. The computing device of claim 16, wherein the AR information manager is configured to compile the real-time limited subset of the higher priority AR requests by including additional AR requests in the real-time limited subset until an aggregate AR request display time exceeds a time limit for substantially real-time display.
